(19) United States
(12) Patent Application Publication
(10) Pub. No.: US 2010/0178123 A1
(43) Pub. Date: Jul. 15, 2010

(54) MACHINE TOOL

(75) Inventors: Uwe Ladra, Erlangen (DE); Gabriele Schmitt-Braess, Erlangen (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, Munchen (DE)

(21) Appl. No.: 12/602,920

(22) PCT Filed: May 28, 2008
(86) PCT No.: PCT/EP2008/056544

§ 371 Date: Dec. 3, 2009

(30) Foreign Application Priority Data
Jun. 4, 2007 (DE) 10 2007 025 934.6

(51) Int. Cl. B23Q 11/00; B23Q 1/34; B23Q 1/70

(52) U.S. Cl. 409/141; 409/231

(57) ABSTRACT

The invention relates to a machine tool, wherein the machine tool (1) has a spindle (4), wherein the spindle (4) is rotatably arranged in a spindle housing (8), and wherein a body (3) which surrounds the spindle rotary axis (9) is coupled to the spindle housing (8) via spring elements and/or active actuator elements. The invention also relates to a machine tool, wherein the machine tool (1) has a spindle (4) which is rotatably arranged in a spindle housing (8), and wherein at least two mass bodies are coupled to the spindle housing (8) via spring elements and/or active actuator elements. The invention creates a machine tool (1) for which vibrations occurring during a machining process are reduced.

The invention relates to a machine tool.

In the case of a machine tool, for example in the case of machining of a workpiece by milling or turning, machining forces occur between the tool and the workpiece. Depending on the dynamic compliance of the machine tool, on the one hand, but also influenced by technology parameters of the cutting process and of the workpiece material, on the other hand, there results therefrom, at the so-termed “tool center-point” (TCP), a functional loop that puts the machining forces into relation with the deflections at the tool center-point resulting therefrom. Such a functional loop can be rendered instable if, in the case of the required cutting frequency selected in the machining of the workpiece, for example, the selected width of cut is too great, i.e. if advance is effected too rapidly. In the case of the occurrence of such self-exciting vibrations, one refers to so-termed chatter vibrations. These acoustically clearly perceptible chatter vibrations leave behind on the workpiece surface, in the pattern of the chatter vibration frequency, so-termed chatter marks, which have a very negative effect upon the surface quality. For this reason, it is necessary to take measures to prevent chatter vibrations.

A customary method of reducing chatter vibrations consists in rendering the cutting process more conservative. In this case, the actually required width of cut continues to be reduced until no further chatter vibrations occur. This measure, however, necessitates an increase in the machining time, and thereby a reduction of the efficiency of the machine tool, and therefore constitutes merely an inadequate solution.

The invention is based on the object of creating a machine tool in which vibrations occurring during a machining operation are reduced.

This object is achieved by a machine tool, the machine tool having a spindle, the spindle being arranged to be rotatable in a spindle housing, a body that surrounds the spindle rotational axis being coupled onto the spindle housing via spring elements and/or active positioning elements.

Furthermore, this object is achieved by a machine tool, the machine tool having a spindle, the spindle being arranged to be rotatable in a spindle housing, at least two mass bodies being coupled onto the spindle housing via spring elements and/or active positioning elements.

Advantageous developments of the invention are given by the dependent claims.

It proves to be advantageous if the body is realized as a ring or as a tube, since there is then obtained an arrangement that is particularly simple to realize in respect of mechanical design.

It proves to be advantageous if the spring elements and/or active positioning elements are arranged to be rotatable about the spindle rotational axis, since the absorber can then be aligned with the vibrational direction of the vibrations. For this purpose, a bearing ring that is rotatable about the spindle rotational axis can be rotatably mounted on the spindle housing, the spring elements and/or active positioning elements being connected to the rotatable bearing ring and the surrounding body.

It proves to be advantageous if the body is arranged coaxially around the spindle rotational axis, since the mass of the surrounding body is then distributed uniformly around the spindle housing and around the spindle, this having a favorable effect upon the dynamic machine behavior of the machine tool.

Furthermore, it proves to be advantageous if the spring elements and/or active positioning elements are arranged on mutually opposite sides of the surrounding body, since a particularly large reduction of the vibrations is then rendered possible.

Furthermore, it proves to be advantageous if the spring elements and/or active positioning elements are arranged in the direction of a linear machine axis for the linear traverse of the spindle, because the machine generally has the least stiffness in the direction of the linear machine axes and, consequently, vibrations preferentially occur in the direction of the linear machine axes.

Further, it proves to be advantageous if the surrounding body is arranged at the tool-side end of the spindle housing, since vibrations can then be suppressed particularly effectively, since these vibrations are damped in the immediate proximity of the site of origin.

Further, it proves to be advantageous if the spring elements and/or active positioning elements are arranged to be rotatable about the spindle rotational axis, since the absorber can then be aligned with the vibrational direction of the vibrations. For this purpose, a bearing ring that is rotatable about the spindle rotational axis can be rotatably mounted on the spindle housing, the spring elements and/or active positioning elements being connected to the rotatable bearing ring and the mass bodies.

Furthermore, it proves to be advantageous if a first mass body is arranged in the direction of a first linear machine axis for the linear traverse of the spindle and a second mass body is arranged in the direction of a second linear machine axis for the linear traverse of the spindle, because the machine generally has the least stiffness in the direction of the linear machine axes and, consequently, vibrations preferentially occur in the direction of the linear machine axes.

Furthermore, it proves to be advantageous if the two mass bodies are arranged at the tool-side end of the spindle housing, since vibrations can then be suppressed particularly effectively, since these vibrations are damped in the immediate proximity of the site of origin.

Furthermore, it proves to be advantageous if the active positioning elements are realized as piezo-actuators. Realization of the positioning elements as piezo-actuators constitutes a usual realization of the positioning elements.

Further, it proves to be advantageous if a sensor, particularly an acceleration sensor, is arranged, respectively, on the spindle housing and on the body or on the spindle housing and on the mass bodies. This measure renders possible a precise determination of the speed difference between the speed of the spindle housing and the speed of the surrounding body or between the speed of the spindle housing and the speed of the mass bodies. In this case, the sensors arranged on the spindle housing can be attached, for example, to the spindle housing or, alternatively, to the bearing ring.

Further, it proves to be advantageous if the machine tool has a closed-loop control device, the closed-loop control device being connected to the sensors and, via a driving device, connected to the positioning elements, the closed-loop control device generating a drive signal for the purpose of driving the positioning elements, according to the speed difference between the speed of the spindle housing and the speed of the body or between the speed of the spindle housing and the speed of the mass bodies. Exact driving of the positioning elements is thereby rendered possible.

Two exemplary embodiments of the invention are represented in the drawing and explained more fully in the following. In the drawing:

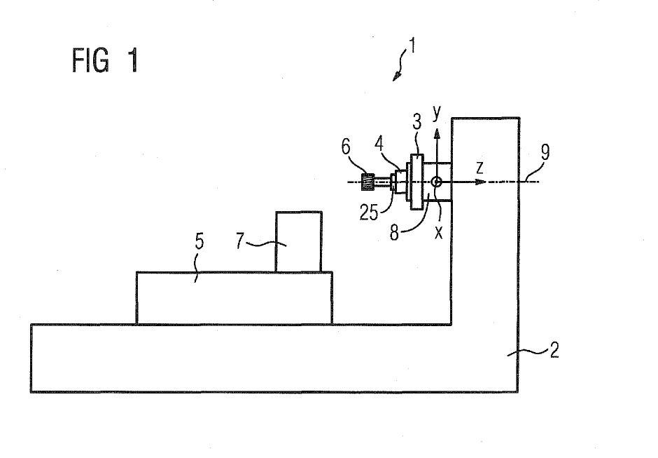

FIG. 1 shows a schematic representation of a machine tool,

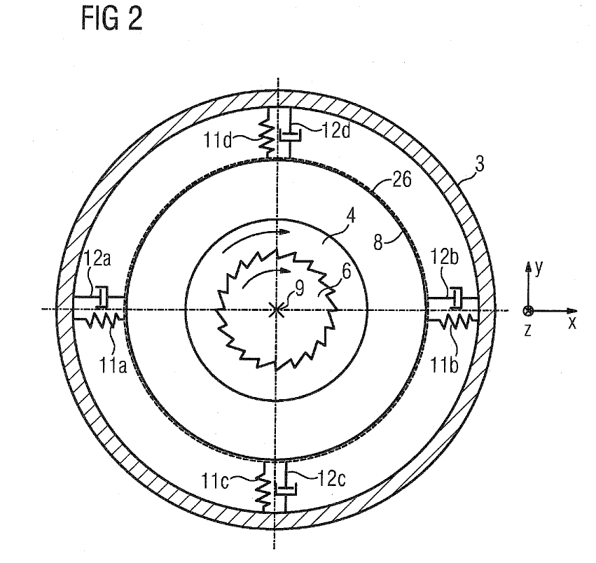

FIG. 2 shows a schematic representation of a spindle having a coupled-on ring according to the invention,

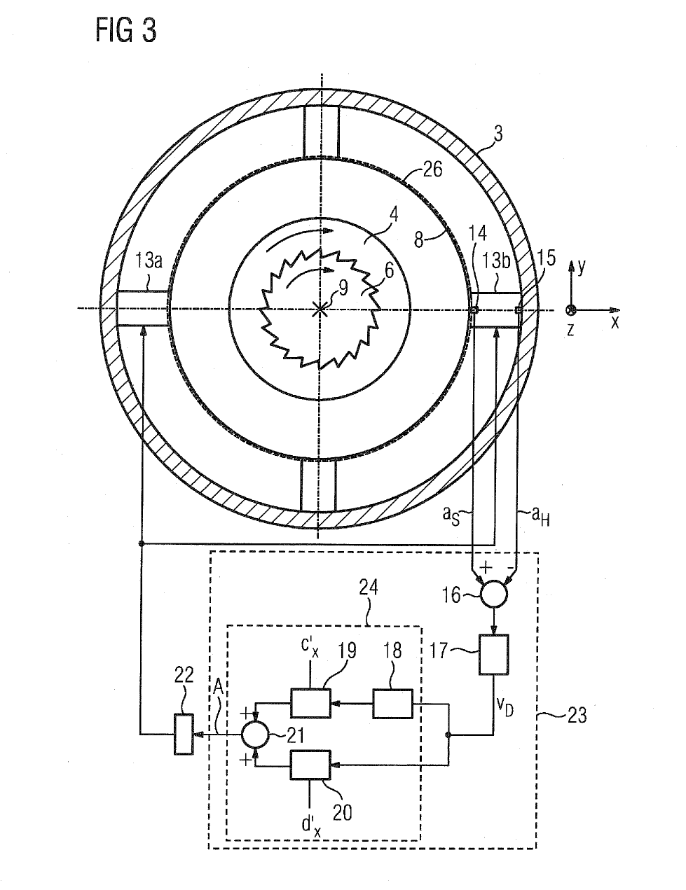

FIG. 3 shows a further embodiment of the invention having active positioning elements, and

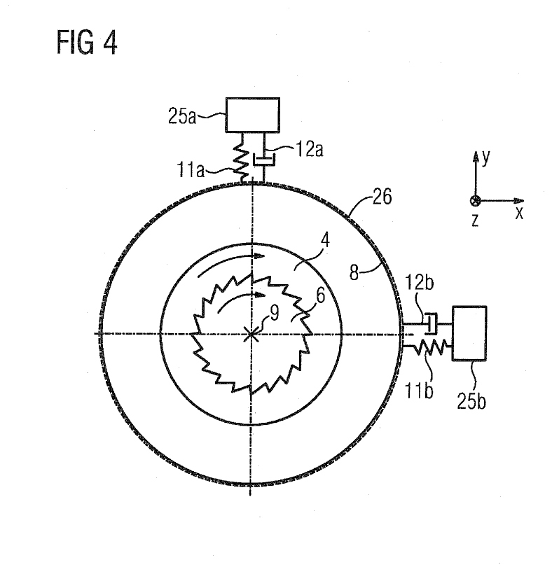

FIG. 4 shows a further embodiment of the invention, with the use of mass bodies.

Represented in FIG. 1, in the form of a schematic representation, is a machine tool 1, which, in the context of the exemplary embodiment, is realized as a milling machine. The machine tool 1 has a stationary machine bed 2, and has a traversable workpiece holding device 5, into which a workpiece 7 is clamped. Furthermore, the machine tool 1 has a spindle 4, mounted to be rotatable in a spindle housing 8. A drive, for driving the spindle 4 in rotation, is integrated into the spindle housing 8. The spindle 4 is realized in the general form of a shaft, the spindle 4 being, in the case of a directly driven spindle, in the form of a motor shaft. A tool receiving device 25, for receiving a tool 6, which, in the context of the exemplary embodiment, is realized as a milling cutter, is arranged at the tool-side end on the spindle 4. The spindle 4 rotates about the spindle rotational axis 9, which, in the context of the exemplary embodiment, lies in the Z direction. The spindle 4 can be traversed linearly in the X direction and in the Y direction by means of drives, which, for reasons of clarity, are not represented. In such a manner, the machine tool has three linearly traversable machine axes, two machine axes being constituted by the spindle that is traversable in the X and the Y direction, and one machine axis being constituted by the workpiece holding device that is traversable in the Z direction.

According to the invention, in the context of a first embodiment of the invention, a body 3, which surrounds the spindle rotational axis and which, in the context of the exemplary embodiment, is realized as a ring, is coupled onto the spindle housing 8 via spring elements or active positioning elements, the coupling-on being realized, in the context of the exemplary embodiment, in such a way that the surrounding body, and particularly the ring 3, is connected to the spindle housing via spring elements or active positioning elements.

Represented in FIG. 2 is a top view, in the Z direction, of the spindle 4, the tool 6, the spindle housing 8 and the ring 3. The ring 3 in this case is arranged coaxially, i.e. at a uniform distance from the spindle rotational axis 9, in order to ensure a symmetrical mass distribution of the ring. It is to be noted at this point that, in the exemplary embodiment, the surrounding body may be realized as a ring and also, in the case of corresponding longitudinal extension of the ring, in the form of a tube, the ring or the tube also being realizable as a polygonal ring or polygonal tube, and not necessarily having to be of a round shape. In the context of the exemplary embodiment, the ring 3 is connected to the spindle housing 8 via four spring elements, which, in the context of the exemplary embodiment, are realized as springs, the spring elements being arranged on mutually opposite sides of the surrounding body 3, in order to achieve an optimized effect. In order to achieve an optimal effect, the spring elements in this case are preferably arranged in the direction of the linear machine axes in the X direction and Y direction, in which the linear traverse movement of the spindle occurs. For the purpose of further optimizing the effect, the surrounding body in this case is preferably arranged in the immediate proximity of the tool-side end of the spindle housing. The rotary motion of the spindle 4 and of the tool 6 are indicated by two arrows.

For the purpose of suppressing the vibrations that occur during the machining process, particularly the chatter vibrations, as already described above, the invention makes provision whereby a body 3, which surrounds the spindle rotational axis 9, is coupled onto the spindle housing via spring elements. The body 3 in this case is fastened to the spindle housing 8 via spring elements 11a, 11b, 11c and 11d. The closer to the tool receiving device 25 the surrounding body 3 is arranged, the more efficiently it functions. In principle, in this case, the spring elements can be arranged in all three cartesian directions (X, Y, Z), at least one spring-element mounting, reduced to one plane (X, Y) being sufficient, since the vibrations of the spindle that are responsible for the chatter vibrations occur mainly, in the context of the exemplary embodiment, in the plane (X, Y) spanned by the X direction and Y direction.

The surrounding body in this case has the mass m. In order for the spring stiffnesses c_{X} and c_{Y} of the spring elements that are arranged in the X direction and Y direction to be dimensioned appropriately, it is necessary to suppress the resonant frequency responsible for the occurring vibrations, particularly that responsible for the occurring chatter vibrations. For this purpose, the resonant frequency to be suppressed can be determined, for example empirically, by means of an appropriate measuring arrangement. For this purpose, it is recommended, for example, to measure the compliance frequency responses in the X direction and in the Y direction. In order to suppress the respective resonant frequency in the X direction f_{kritX} and in the Y direction f_{kritY}, the spring stiffness c_{X} of the spring elements in the X direction 11a and 11b and the spring stiffness c_{Y} of the spring elements in the Y direction 11c and 11d are determined as:

c_{X}=0.5·m·(2·π·f_{kritX})²

c_{Y}=0.5·m·(2·π·f_{kritY})²

The absorber constituted by the surrounding body 3 and the spring elements 11a, 11b, 11c and 11d can thus be dimensioned separately for the X direction and for the Y direction, as described above, through the selection of the corresponding spring stiffnesses c_{X} and c_{Y}. When the absorber is attached to the spindle housing, superimposition of the two effective directions results in a reduction of the corresponding spindle vibrations that is effective in the entire X/Y plane. The chatter vibrations therefore start only at a later point, i.e. in the case of machining of a workpiece, greater widths of cut are rendered possible without chatter marks appearing on the surface of the workpiece.

The surrounding body can then also be coupled onto the spindle housing 8 by means of damping elements 12a, 12b, 12c and 12d, in addition to the spring elements. The damping elements cause energy to be taken out of the absorber. For this purpose, in the context of the exemplary embodiment, the surrounding body is additionally connected to the spindle housing via the damping elements, which may be provided, for example, in the form of shock absorbers.

It is advantageous if the spring elements and/or active positioning elements are arranged to be rotatable about the spindle rotational axis, since the absorber can then be aligned with the vibrational direction of the vibrations. For this purpose, for example, a bearing ring 26, which is rotatable about the spindle rotational axis, can additionally be attached to the spindle housing, this being indicated in the figures by a broken line, the spring elements and/or active positioning elements in this case being connected to the rotatable bearing ring 26, such that the absorber can be rotated about the spindle rotational axis.

A further embodiment of the invention is represented in FIG. 3. This embodiment corresponds substantially, in its basic structure, to the embodiment described previously in the case of FIGS. 1 and 2. Elements that are the same are therefore given the same references in FIG. 3 as in FIGS. 1 and 2. The essential difference in FIG. 3, compared with the embodiment according to FIG. 2, consists in that, in the case of the embodiment according to FIG. 3, the spring elements have been replaced by active positioning elements, preferably realized as piezo-actuators. Additionally provided are sensors, which enable the speed difference V_{D} between the spindle housing 8 and the surrounding body 3 to be determined, both in the X direction and in the Y direction. The speed difference v_{D} is determined for each cartesian direction X and Y, and a drive signal, for driving the positioning elements according to the speed difference, is generated. If the controller is realized as a purely integrating controller, its gain can be used to set the equivalent to the spring stiffness in the case of use of spring elements. If a proportional-plus-integral controller is used as the controller, the gain of the additional proportional channel makes available an equivalent for a viscous damping, which corresponds to the use of the damping elements according to the embodiment according to FIG. 2 and which can be used for the purpose of further optimization.

In FIG. 3, for reasons of clarity, the corresponding arrangement is represented and denoted by references for the X direction only, the positioning elements for the Y direction not being included. An identical structure is obtained for the Y direction, for which reason this structure is not represented in FIG. 3 for reasons of clarity. The acceleration of the spindle housing a_{S} in the X direction is measured by means of a first sensor 14, which is attached to the spindle housing 8 and which, in the context of the exemplary embodiment, is realized as an acceleration sensor, and the acceleration of the surrounding body a_{H} in the X direction is measured by means of a second sensor 15, which, in the context of the exemplary embodiment, is realized as an acceleration sensor. The acceleration of the spindle housing a_{S} and that of the surrounding body a_{H} are supplied, as input quantities, to a subtractor 16, and the acceleration difference determined in such a manner is supplied to an integrator 17, which, by means of integration of the input signal, determines the speed difference v_{D} between the speed of the spindle housing and the speed of the surrounding body. The speed difference v_{D} is then supplied, as an input quantity, to an integrator 18, which, on the output side, outputs a position difference signal to a multiplier 19, which multiplies the position difference signal by a factor c_{X}′, which represents an analogue to the spring stiffness, and, on the output side, outputs the multiplied signal to an adder 21. In parallel thereto, the speed difference V_{D} is multiplied, by means of a multiplier 20, by a factor d_{X}′, which represents an analogue to the damping constant, and the output signal generated in such a manner is supplied, as an input signal quantity, to the adder 21. The adder 21 adds the two signals and in such a manner generates, on the output side, a drive signal A for the purpose of driving the positioning elements 13a and 13b. The drive signal A is supplied, as an input quantity, to a driving device 22, which, from the drive signal A, generates a corresponding drive voltage for the purpose of driving the positioning elements 13a and 13b. In the context of the exemplary embodiment, the subtractor 16, the integrators 17 and 18, the multipliers 19 and 20, and the adder 21 are integral constituent parts of a closed-loop control device 23. The integrator 18, the two multipliers 19 and 20 and the adder 21 constitute a proportional-plus-integral controller 24. As already described above, a pure integral controller may also be used instead of the proportional-plus-integral controller 24. In this case, only the integrator 18 and the multiplier 19 would be present.

In the context of the exemplary embodiment, the driving device 22 is realized as a component that is separate from the closed-loop control device 23, but clearly this component may also be an integral constituent part of the closed-loop control device 23.

A further embodiment of the invention is represented in FIG. 4. The embodiment represented in FIG. 4 corresponds substantially, in respect of its basic structure, to the embodiment described previously in FIG. 2. Elements that are the same are therefore denoted by the same references in FIG. 4 as in FIG. 2. The essential difference consists in that, in the case of the embodiment according to FIG. 4, two mass bodies are used instead of the surrounding body. A first mass body 25a serves to reduce the vibrations of the spindle in the Y direction, and a second mass body 25b serves to reduce the vibrations of the spindle 4 in the X direction. In the context of the exemplary embodiment, the two mass bodies in this case are preferably offset substantially by 90° relative to one another, in relation to the spindle rotational axis 9, in particular offset by 90° relative to one another. The two mass bodies 25a and 25b are coupled onto the spindle housing 8 via respectively assigned spring elements 11a and 11b, in that, in the context of the exemplary embodiment, they are connected to the spindle housing 8. In addition thereto, the two mass bodies 25a and 25b may likewise be coupled-on via damping elements 12a and 12b, exactly as in the case of the exemplary embodiment according to FIG. 2. For the purpose of further optimizing the effect, the mass bodies in this case are preferably arranged in the immediate proximity of the tool-side end of the spindle housing.

The functioning principle is otherwise identical to that of the embodiment according to FIG. 2, such that there is no need for repeated description at this point. In the case of the embodiment according to FIG. 4, the spring stiffnesses c_{X} and c_{Y} of the spring elements 11a and 11b are given as:

c_{X}=m_{X}·(2·π·f_{kritX})²

c_{Y}=m_{Y}·(2·π·f_{kritY})²

In this case, the mass m_{Y} of the first mass body 25a and the mass m_{X} of the second mass body 25b may be identical or differing.

Clearly, exactly as in the case of the embodiment according to FIG. 3, in the case of the embodiment according to FIG. 4 also the spring elements and damping elements may be replaced by active positioning elements such as, for example, piezo-actuators, which are correspondingly driven, in analogous manner, by means of a closed-loop control device of analogous structure (as represented in FIG. 3). Provided in this case, analogously, are sensors that enable the speed difference between the mass bodies and the spindle housing to be determined.

It is to be noted at this point that the embodiment according to FIG. 4 may likewise, in analogous form, have a rotatable bearing ring 26, by means of which the two mass bodies can be rotated about the spindle rotational axis.

The embodiment according to FIGS. 2 and 3, wherein a body 3, particularly a ring or a tube, that surrounds the spindle rotational axis is used, provides for a simpler mechanical structure, compared with the embodiment according to FIG. 4, and additionally provides for a symmetrical distribution of mass, such that the machining behavior of the machine is not substantially affected by the additional structure.

The invention has the great advantage that the mass of the absorber is relatively small in comparison with the total mass of the spindle and the spindle housing, such that the invention has only an insignificant effect upon the machine dynamics. Consequently, the machine axes can be traversed with virtually the same acceleration values as without the absorber, such that, compared with solutions known from the prior art, there is virtually no increase in machining times resulting from use of the invention.

Furthermore, it is to be noted at this point that, clearly, the surrounding body or the mass bodies may also be coupled onto the spindle housing via spring elements and active positioning elements simultaneously. This makes it possible, for example, in the case of a hardware failure of the driving device, to remove the positioning elements and to continue operation of the machine using the spring elements.

If a plurality of vibrational frequencies are to be suppressed simultaneously, it is also possible for a plurality of absorbers according to the invention, tuned to respectively differing frequencies, to be simultaneously coupled to the spindle housing, in that these absorbers are arranged, for example, on the spindle housing, in axial succession along the spindle rotational axis.

1.-14. (canceled)

15. A machine tool, comprising:
a spindle housing;
a spindle arranged in the spindle housing for rotation about a rotational axis; and
a body surrounding the spindle housing and being coupled to the spindle housing via spring elements or active positioning elements, or both.

16. The machine tool of claim 15, wherein the body is configured as a ring or as a tube.

17. The machine tool of claim 15, wherein the spring elements or active positioning elements are arranged for rotation about the rotational axis.

18. The machine tool of claim 15, wherein the body is arranged coaxially around the rotational axis.

19. The machine tool of claim 15, wherein the spring elements or active positioning elements are arranged on opposing sides of the body.

20. The machine tool of claim 19, wherein the machine tool defines at least one machine axis configured for linear travel of the spindle, with the spring elements or active positioning elements being arranged in a direction of the at least one linear machine axis.

21. The machine tool of claim 15, wherein the body is arranged at a tool-side end of the spindle housing.

22. The machine tool of claim 15, wherein the active positioning elements are constructed as piezo-actuators.

23. The machine tool of claim 15, further comprising sensors arranged on the spindle housing and on the body.

24. The machine tool of claim 23, wherein the sensors are acceleration sensors.

25. The machine tool of claim 23, further comprising a closed-loop control device connected to the sensors, and a drive unit connected between the closed-loop control and the active positioning elements, wherein the active positioning elements are driven by the drive unit in response to a drive signal generated by the closed-loop control device commensurate with a speed difference between a speed of the spindle housing and a speed of the body.

26. A machine tool, comprising:
a spindle housing;
a spindle arranged in the spindle housing for rotation about a rotational axis;
a drive rotating the spindle and integrated into the spindle housing; and
at least two mass bodies coupled to the spindle housing via spring elements or active positioning elements, or both.

27. The machine tool of claim 26, wherein the spring elements and/or active positioning elements are arranged for rotation about the rotational axis.

28. The machine tool of claim 26, wherein the machine tool defines at least two linear machine axes configured for linear travel of the spindle, with a first of the at least two mass bodies being arranged in a direction of a first of the at least two linear machine axes and a second of the at least two mass bodies being arranged in a direction of a second of the at least two linear machine axes.

29. The machine tool of claim 26, wherein the two mass bodies are arranged at a tool-side end of the spindle housing.

30. The machine tool of claim 26, wherein the active positioning elements are constructed as piezo-actuators.

31. The machine tool of claim 26, further comprising sensors arranged on the spindle housing and on the mass bodies.

32. The machine tool of claim 31, wherein the sensors are acceleration sensors.

33. The machine tool of claim 31, further comprising a closed-loop control device connected to the sensors, and a drive unit connected between the closed-loop control and the active positioning elements, wherein the active positioning elements are driven by the drive unit in response to a drive signal generated by the closed-loop control device commensurate with a speed difference between a speed of the spindle housing and a speed of the mass bodies.
